(19) United States
(12) Patent Application Publication
(10) Pub. No.: US 2025/0300404 A1
(43) Pub. Date: Sep. 25, 2025

(54) Connector Blind Plug Assembly and Connector

(71) Applicants: Tyco Electronics Technology (SIP) Co., Ltd., Suzhou (CN); Tyco Electronics (Shanghai) Co., Ltd., Shanghai (CN)

(72) Inventors: Jianxiong (Jesse) Li, Shanghai (CN); Reicky Zhang, Shanghai (CN); Neil Shi, Shanghai (CN); Lei Li, Suzhou (CN); Tomo Hu, Suzhou (CN)

(73) Assignees: Tyco Electronics Technology (SIP) Co., Ltd., Suzhou (CN); Tyco Electronics (Shanghai) Co., Ltd., Shanghai (CN)

(21) Appl. No.: 19/083,989

(22) Filed: Mar. 19, 2025

(30) Foreign Application Priority Data
Mar. 19, 2024 (CN) 202410316310.8

(51) Int. Cl. H01R 13/6581; H01R 13/52

(52) U.S. Cl. CPC H01R 13/6581; H01R 13/5202

(57) ABSTRACT

A connector blind plug assembly includes a shield blocking component and a port blocking component. The shield blocking component mates with a rear end of a cylindrical shield of a connector. The shield blocking component blocks a rear end opening of the cylindrical shield and prevents electromagnetic leakage. The port blocking component cooperates with a sealing ring to block and seal a rear port of an installation hole of a connector housing. The connector blind plug assembly replaces a cable assembly of the connector and is inserted into the installation hole of the connector housing to block the installation hole.

### CROSS-REFERENCE TO RELATED APPLICATION

This application claims the benefit of the filing date under 35 U.S.C. § 119 (a)-(d) of Chinese Patent Application No. CN202410316310.8 filed on Mar. 19, 2024.

### FIELD OF THE INVENTION

The present invention relates to a plug assembly and, more particularly, to a connector blind plug assembly and a connector comprising the connector blind plug assembly.

### BACKGROUND OF THE INVENTION

In the prior art, a connector typically includes a housing, a shielding shell, a terminal holder, and a cable assembly. The shielding shell is installed into the housing, and an installation hole is formed in the housing. The terminal holder is inserted into the installation hole of the housing and accommodated in the shielding shell. The cable assembly is inserted into the housing from the rear port of the installation hole. The terminal of the cable assembly is inserted into the terminal holder, and the shielding connection element of the cable assembly is mated with the rear end of the shielding shell to electrically connect the shielding layer of the cable to the shielding shell. The sealing ring of the cable assembly is fitted onto the cable for sealing the rear end of the installation hole.

In the prior art, for a multi-hole connector with multiple installation holes, not all installation holes need to be used. When all installation holes are not used, blind plugs are used to block the holes that do not have cable assemblies inserted into them. However, the shielding shell of the existing connector is designed as a whole, with different shielding structures for each installation hole, which results in the inability to interchange blind plugs for each installation hole and between blind plugs and cable assemblies, making it inconvenient and inflexible to use.

### SUMMARY OF THE INVENTION

A connector blind plug assembly includes a shield blocking component and a port blocking component. The shield blocking component mates with a rear end of a cylindrical shield of a connector. The shield blocking component blocks a rear end opening of the cylindrical shield and prevents electromagnetic leakage. The port blocking component cooperates with a sealing ring to block and seal a rear port of an installation hole of a connector housing. The connector blind plug assembly replaces a cable assembly of the connector and is inserted into the installation hole of the connector housing to block the installation hole.

### BRIEF DESCRIPTION OF DRAWINGS

The invention will now be described by way of example with reference to the accompanying figures, of which:

FIG. 1 is a perspective view of a connector according to an exemplary embodiment;

FIG. 2 is a longitudinal sectional view of the connector of FIG. 1;

FIG. 3 is a partial exploded longitudinal sectional view of the connector of FIG. 1;

FIG. 4 is a sectional assembly view of a connector blind plug assembly, a cylindrical shield, a terminal holder, a sealing ring, a cable clamp, and a rear end cover of the connector of FIG. 1;

FIG. 5 is a sectional assembly view of a cable assembly, the cylindrical shield of FIG. 4, the terminal holder of FIG. 4, the sealing ring of FIG. 4, the cable clamp of FIG. 4, and a rear end cover of FIG. 4 of the connector of FIG. 1;

FIG. 6 is a perspective view of the connector blind plug assembly of FIG. 4;

FIG. 7 is an axial sectional view of the connector blind plug assembly of FIG. 4;

FIG. 8 is an exploded view of the connector blind plug assembly of FIG. 4;

FIG. 9 is an exploded sectional view of the connector blind plug assembly of FIG. 4; and

FIG. 10 is a perspective sectional view of the cable assembly of FIG. 5.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

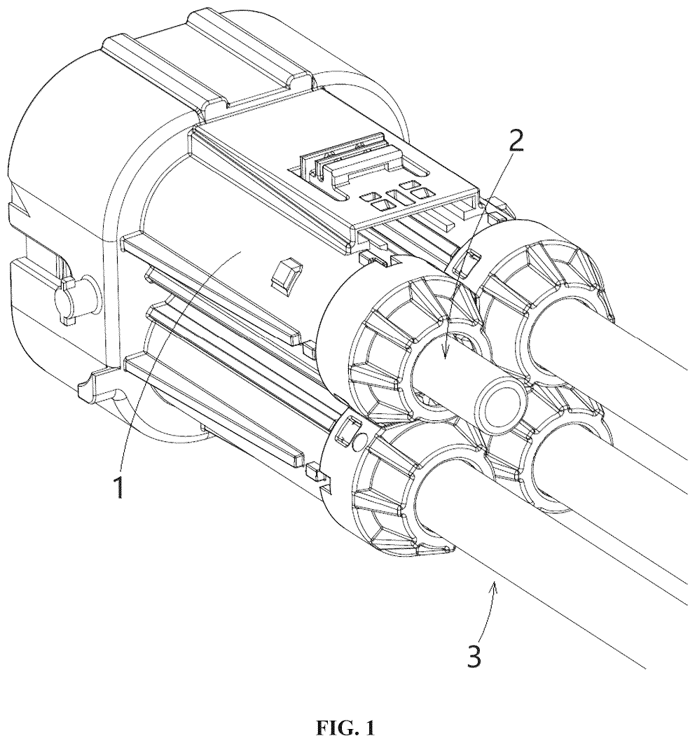

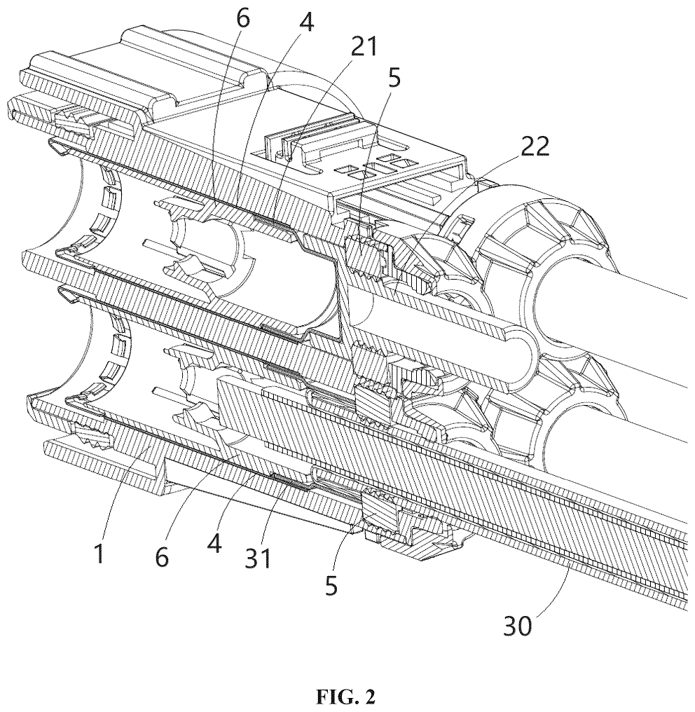

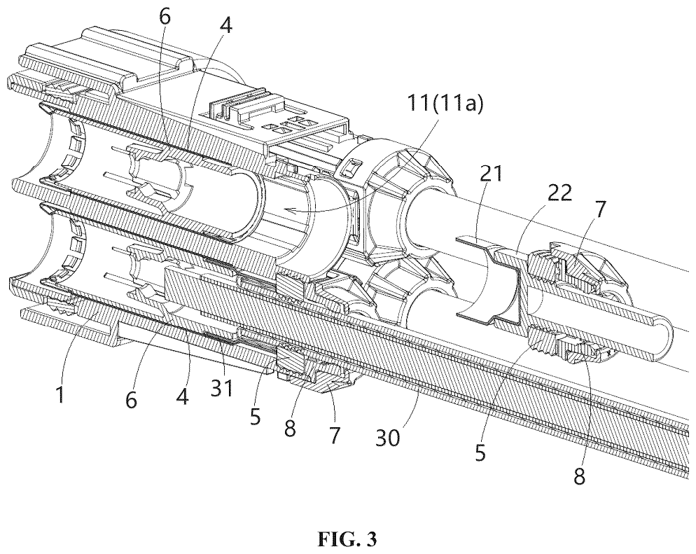

An exemplary embodiment of a connector blind plug assembly 2 is now described with reference to FIGS. 1-10. As shown in FIGS. 2-3, the connector blind plug assembly 2 includes a shield blocking component 21 and a port blocking component 22. The shield blocking component 21 is suitable for mating with a rear end opening of a cylindrical shield 4 of the connector, as shown in FIGS. 2-5, and is used to block the rear end opening of the cylindrical shield 4 to prevent electromagnetic leakage. The shield blocking component 21 can be a metal component. As shown in FIGS. 2-3, the port blocking component 22 is suitable for cooperating with a sealing ring 5 to seal a rear port 11a of an installation hole 11 of the connector housing 1, in order to achieve a waterproof sealing function. The port blocking component 22 can be an insulation component.

As shown in FIG. 1, the connector blind plug assembly 2 can replace the cable assembly 3 of the connector. The connector blind plug assembly 2 is inserted into the installation hole 11 to block the installation hole 11 that does not have the cable assembly 3 inserted into.

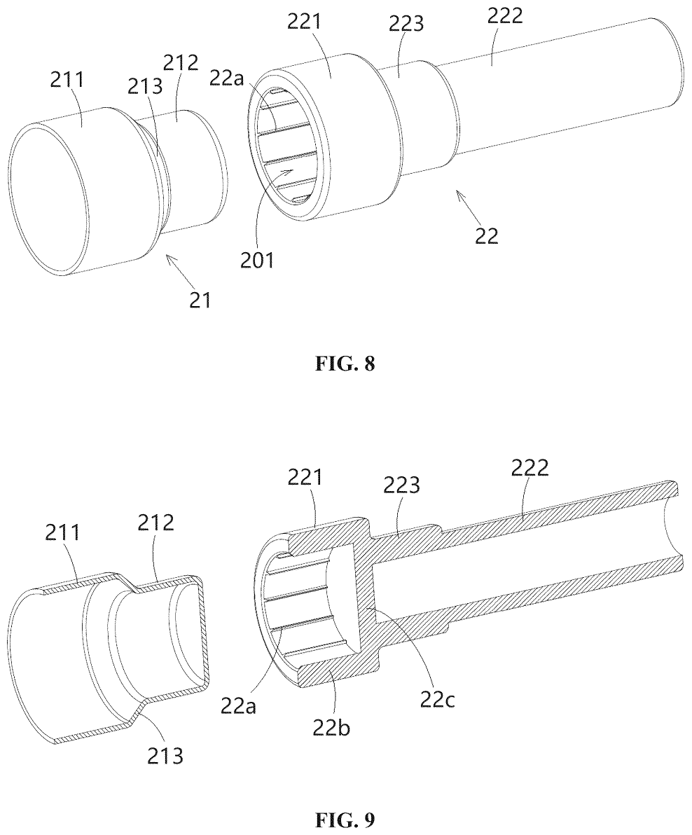

As shown in FIGS. 3 and 8, the shield blocking component 21 has a shape of an end cap with an open front end and a closed rear end. As shown in FIG. 8, the shield blocking component 21 includes a front end part 211 which has a cylindrical shape. The front end part 211 is suitable for being inserted into the rear end opening of the cylindrical shield 4 to block the rear end opening of the cylindrical shield 4.

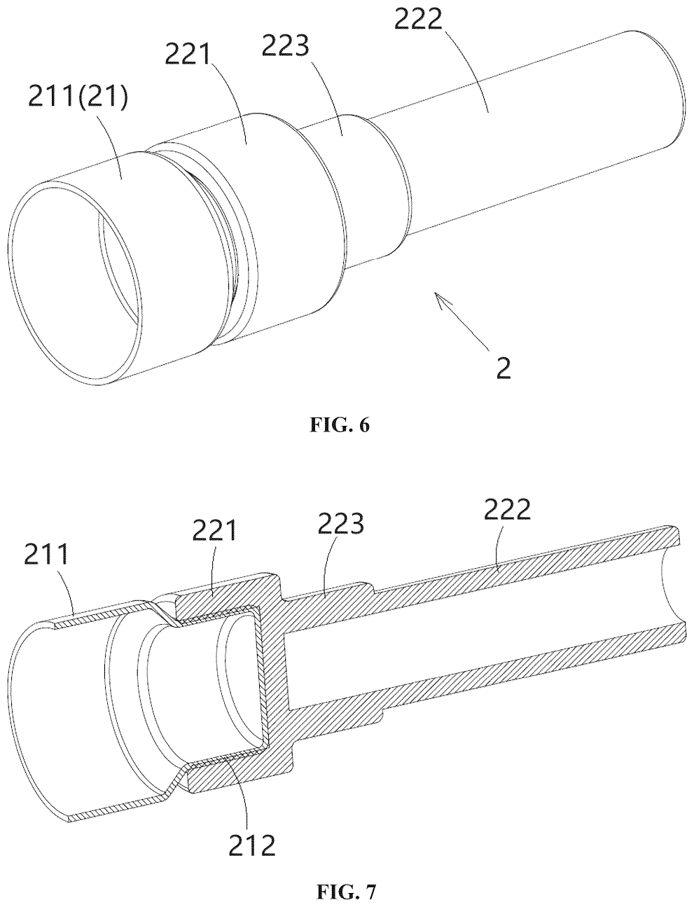

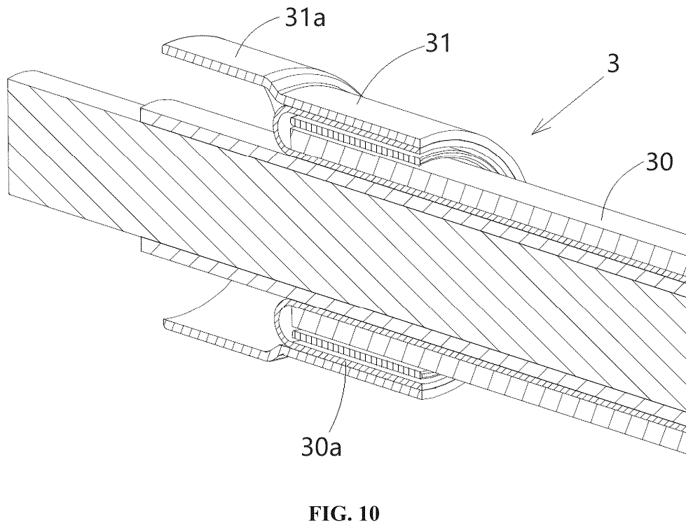

The outer diameter of the front end part 211 of the shield blocking component 21, as shown in FIGS. 6-9, is equal to the outer diameter of the mating end 31a of the shield connection element 31 of the cable assembly 3, as shown in FIG. 10, which is used to mate with the rear end opening of the cylindrical shield 4, so that the shield blocking component 21 can replace the shield connection element 31 to mate with the rear end opening of the cylindrical shield 4.

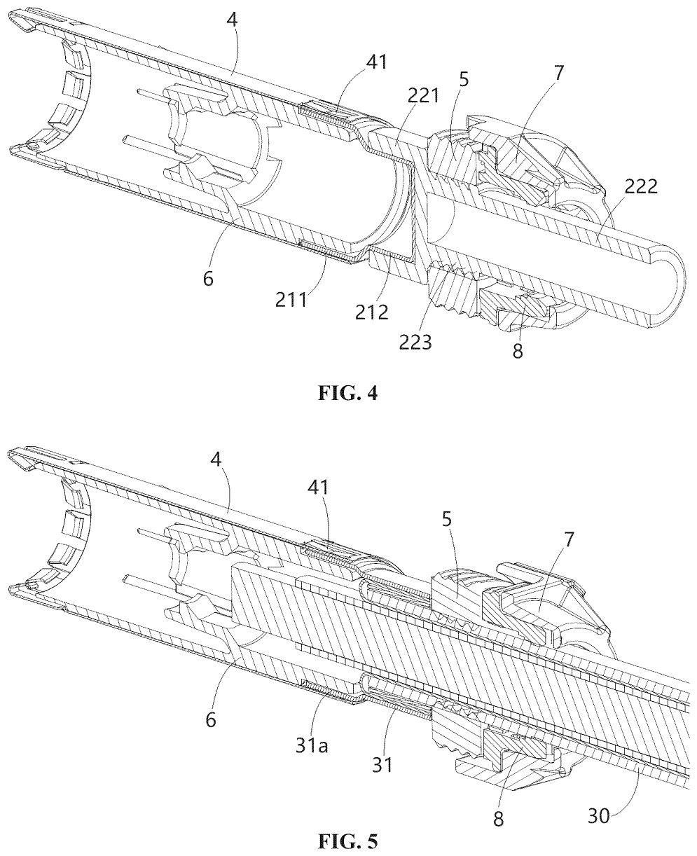

As shown in FIG. 4, the front end part 211 of the shield blocking component 21 is adapted to be fitted onto the rear end of the terminal holder 6 of the connector. The inner diameter of the front end part 211 of the shield blocking component 21, as shown in FIGS. 6-9, is equal to the inner diameter of the mating end 31a of the shield connection element 31, as shown in FIG. 10, so that the shield blocking component 21 can replace the shield connection element 31 to mate with the rear end of the terminal holder 6.

As shown in FIGS. 7 and 9-10, the front end part 211 of the shield blocking component 21 is completely identical to the mating end 31a of the shield connection element 31, so that the shield blocking component 21 can replace the shield connection element 31 to simultaneously mate with the rear end opening of the cylindrical shield 4 and the rear end of the terminal holder 6.

As shown in FIG. 8, the shield blocking component 21 further comprises a rear end part 212 and a middle part 213. The rear end part 212 is cylindrical and fixed to the front end of the port blocking component 22. The middle part 213 is connected between the front end part 211 and the rear end part 212. As shown in FIG. 8, the outer diameter of the rear end part 212 of the shield blocking component 21 is smaller than the outer diameter of the front end part 211. The middle part 213 of the shield blocking component 21 is conical.

As shown in FIGS. 4 and 6-9, the port blocking component 22 includes a sealing ring installation part 223 for installing a sealing ring 5. The outer diameter of the sealing ring installation part 223, as shown in FIGS. 7 and 9, is equal to the outer diameter of the cable 30 of the cable assembly 3, as shown in FIGS. 5 and 10, so that the port blocking component 22 can replace the cable 30 and cooperate with the sealing ring 5 to seal the rear port 11a of the installation hole 11.

As shown in FIGS. 5 and 7-9, the port blocking component 22 further includes a cylindrical installation part 221, which is located at the front end of the port blocking component 22. As shown in FIGS. 8-9, the port blocking component 22 includes an outer peripheral wall 22b and a rear end wall 22c surrounding an insertion cavity 201. The rear end part 212 of the shield blocking component 21 is inserted and fixed into the insertion cavity 201 of the cylindrical installation part 221 of the port blocking component 22.

As shown in FIGS. 8-9, multiple convex ribs 22a are formed on the inner peripheral surface of the insertion cavity 201 of the cylindrical installation part 221. The multiple convex ribs 22a extend along the axial direction of the cylindrical installation part 221 and are distributed at intervals in the circumferential direction of the cylindrical installation part 221. As shown in FIG. 7, the multiple convex ribs 22a fit with the rear end part 212 of the inserted shield blocking component 21 through interference fit.

As shown in FIGS. 6-9, the outer diameter of the sealing ring installation part 223 is smaller than the outer diameter of the cylindrical installation part 221. As shown in FIG. 9, the front end of the sealing ring installation part 223 is connected to the rear end wall 22c of the cylindrical installation part 221.

As shown in FIGS. 4 and 6-9, the port blocking component 22 further includes a cylindrical extension part 222, which is connected to the rear end of the sealing ring installation part 223 and extends a predetermined length backwards from the rear end of the sealing ring installation part 223. The outer diameter of the cylindrical extension part 222, as shown in FIGS. 7 and 9, is equal to or slightly smaller than the outer diameter of the cable 30 of the cable assembly 3, as shown in FIGS. 5 and 10, so as to be able to pass through the cable clamp 8 and the rear end cover 7 of the connector.

The connector blind plug assembly 2 further includes a sealing ring 5, as shown in FIGS. 2-5, which is fitted onto the sealing ring installation part 223 of the port blocking component 22. The sealing ring 5 is suitable for being radially compressed between the outer peripheral surface of the sealing ring installation part 223 and the inner peripheral surface of the rear port 11a of the installation hole 11 to seal the rear port 11a of the installation hole 11.

An exemplary embodiment of a connector is now described with reference to FIGS. 1-10. As shown in FIGS. 1-3, the connector includes the connector housing 1, the cylindrical shield 4, and the connector blind plug assembly 2. As shown in FIG. 3, the connector housing 1 is formed with installation holes 11 for inserting the cable assembly 3. The cylindrical shield 4, as shown in FIGS. 2-5, is inserted into the installation hole 11 of the connector housing 1. As shown in FIG. 2, the connector blind plug assembly 2 replaces the cable assembly 3 of the connector and is inserted into the installation hole 11 to block the installation hole 11 that does not have the cable assembly 3 inserted into. As shown in FIG. 2, the shield blocking component 21 of the connector blind plug assembly 2 is mated with the rear end opening of the cylindrical shield 4 and blocks the rear end opening of the cylindrical shield 4 to prevent electromagnetic leakage.

As shown in FIGS. 4-5, multiple elastic contact arms 41 are formed on the rear end of the cylindrical shield 4, which are distributed at intervals in the circumferential direction of the cylindrical shield 4 and arched towards the interior of the cylindrical shield 4. As shown in FIG. 4, the front end part 211 of the shield blocking component 21 is inserted into the rear end opening of the cylindrical shield 4 and electrically contacts multiple elastic contact arms 41.

As shown in FIGS. 2-5, the connector further comprises the terminal holder 6. The terminal holder 6 is installed in the installation hole 11 of the connector housing 1 to hold the inserted terminal. The terminal may be crimped to one end of the cable 30 of cable assembly 3. As shown in FIG. 4, the cylindrical shield 4 is fitted onto the exterior of the terminal holder 6, and the rear end of the terminal holder 6 is inserted into the front end part 211 of the shield blocking component 21.

As shown in FIG. 3, multiple installation holes 11 are formed in the connector housing 1, and the connector includes multiple cylindrical shields 4 that are respectively inserted into the multiple installation holes 11. The multiple installation holes 11 are independent and identical to each other, and the multiple cylindrical shields 4 are independent and identical to each other, allowing the connector blind plug assembly 2 to be inserted into any of the multiple installation holes 11.

As shown in FIG. 1, the connector further comprises the cable assembly 3. As shown in FIG. 10, the cable assembly 3 includes the cable 30 and a shield connection element 31 crimped onto the shielding layer 30a of the cable 30. The cable assembly 3 is used for insertion into the installation hole 11. The shield connection element 31 has a mating end 31a, as shown in FIG. 10, suitable for mating with the rear end opening of the cylindrical shield 4. At least one of the multiple installation holes 11 is inserted with the cable assembly 3, and the connector blind plug assembly 2 is inserted into the installation hole 11 where cable assembly 3 is not inserted.

As shown in FIG. 1, the connector includes four installation holes 11. The cable assemblies 3 are respectively inserted into three installation holes 11, and one connector blind plug assembly 2 is inserted into one installation hole 11. However, the present invention is not limited to the illustrated embodiment. For example, the cable assembly 3 may not be inserted into any of the multiple installation holes 11 of the connector, and the connector blind plug assemblies 2 may be inserted into each of the multiple installation holes 11.

The cable assembly 3 further includes a terminal that is crimped onto one end of the cable 30 and adapted to be inserted into the terminal holder 6 for mating with a mating terminal of a mating connector.

As shown in FIGS. 3-5, the connector further comprises the rear end cover 7 and the cable clamp 8. The rear end cover 7 is locked onto the rear end of the connector housing 1. The cable clamp 8 is accommodated in the rear end cover 7. As shown in FIG. 4, the cylindrical extension part 222 of the port blocking component 22 of the connector blind plug assembly 2 passes through the cable clamp 8 and the rear end cover 7, and is fixed to the rear end of the connector housing 1 by the cable clamp 8 and the rear end cover 7.

In the aforementioned exemplary embodiments according to the present invention, the connector blind plug assembly 2 can simultaneously block the rear end opening of the cylindrical shield 4 and the rear port 11a of the installation hole 11 of the connector housing 1, and can replace the cable assembly 3 of the connector to block the installation hole 11 that does not have the cable assembly 3 inserted into, thereby improving the convenience and flexibility of use.

It should be appreciated for those skilled in this art that the above embodiments are intended to be illustrative and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A connector blind plug assembly, comprising:
a shield blocking component mating with a rear end of a cylindrical shield of a connector, the shield blocking component blocks a rear end opening of the cylindrical shield and prevents electromagnetic leakage; and
a port blocking component cooperating with a sealing ring to block and seal a rear port of an installation hole of a connector housing, the connector blind plug assembly replaces a cable assembly of the connector and is inserted into the installation hole of the connector housing to block the installation hole.

2. The connector blind plug assembly of claim 1, wherein the shield blocking component has an end cap shape, the end cap shape has an open front end and a closed rear end, the shield blocking component has a front end part which is cylindrical, the front end part is inserted into the rear end opening of the cylindrical shield and blocks the rear end opening of the cylindrical shield.

3. The connector blind plug assembly of claim 2, wherein an outer diameter of the front end part of the shield blocking component is equal to an outer diameter of a mating end of a shield connection element of the cable assembly, the front end part mates with the rear end opening of the cylindrical shield and replaces the shield connection element to mate with the rear end opening of the cylindrical shield.

4. The connector blind plug assembly of claim 3, wherein the front end part of the shield blocking component fits onto a rear end of a terminal holder of the connector, and an inner diameter of the front end part of the shield blocking component is equal to an inner diameter of the mating end of the shield connection element, the shield blocking component replaces the shield connection element and mates with the rear end of the terminal holder.

5. The connector blind plug assembly of claim 4, wherein the front end part of the shield blocking component is identical to the mating end of the shield connection element, the shield blocking component replaces the shield connection element to simultaneously mate with the rear end opening of the cylindrical shield and the rear end of the terminal holder.

6. The connector blind plug assembly of claim 2, wherein the shield blocking component has a rear end part which is cylindrical and fixed to a front end of the port blocking component, and a middle part connected between the front end part and a rear end part of the shield blocking component, an outer diameter of the rear end part is smaller than an outer diameter of the front end part, and the middle part is conical.

7. The connector blind plug assembly of claim 1, wherein the port blocking component comprises a sealing ring installation part, the sealing ring is installed on the sealing ring installation part, an outer diameter of the sealing ring installation part is equal to an outer diameter of a cable of the cable assembly, the port blocking component replaces the cable and cooperates with the sealing ring to seal the rear port of the installation hole.

8. The connector blind plug assembly of claim 7, wherein the port blocking component has a cylindrical installation part located at a front end of the port blocking component and an outer peripheral wall and a rear end wall enclosing an insertion cavity, a rear end part of the shield blocking component is inserted and fixed into the insertion cavity of the cylindrical installation part.

9. The connector blind plug assembly of claim 8, wherein a plurality of convex ribs are formed on an inner peripheral surface of the insertion cavity, each convex rib extends along an axial direction of the cylindrical installation part and is distributed at intervals in a circumferential direction of the cylindrical installation part, the convex ribs fit with the rear end part of the shield blocking component through an interference fit.

10. The connector blind plug assembly of claim 9, wherein the outer diameter of the sealing ring installation part is smaller than an outer diameter of the cylindrical installation part, a front end of the sealing ring installation part is connected to the rear end wall of the cylindrical installation part.

11. The connector blind plug assembly of claim 10, wherein the port blocking component has a cylindrical extension part connected to the rear end of the sealing ring installation part and extending a predetermined length backwards from the rear end of the sealing ring installation part, the outer diameter of the cylindrical extension part is equal to or smaller than the outer diameter of the cable of the cable assembly, the cylindrical extension part passes through a cable clamp and a rear end cover of the connector.

12. The connector blind plug assembly of claim 7, further comprising a sealing ring which is fitted onto the sealing ring installation part of the port blocking component, the sealing ring is radially compressed between an outer peripheral surface of the sealing ring installation part and an inner peripheral surface of the rear port of the installation hole, the sealing ring seals the rear port of the installation hole.

13. A connector, comprising:
a connector housing formed with an installation hole receiving a cable assembly;
a cylindrical shield inserted into the installation hole of the connector housing; and
a connector blind plug assembly including a shield blocking component and a port blocking component, the shield blocking component mates with a rear end of the cylindrical shield, the shield blocking component blocks a rear end opening of the cylindrical shield and prevents electromagnetic leakage, and the port blocking component cooperates with a sealing ring to block and seal a rear port of the installation hole, the connector blind plug assembly replaces the cable assembly of the connector and is inserted into the installation hole to block the installation hole, the shield blocking component of the connector blind plug assembly mates with the rear end opening of the cylindrical shield and blocks the rear end opening of the cylindrical shield preventing electromagnetic leakage.

14. The connector of claim 13, wherein a plurality of elastic contact arms are formed on the rear end of the cylindrical shield, the plurality of elastic contact arms are distributed at intervals in a circumferential direction of the cylindrical shield and arch towards an interior of the cylindrical shield, a front end part of the shield blocking component is inserted into the rear end opening of the cylindrical shield and electrically contacts the plurality of elastic contact arms.

15. The connector of claim 13, further comprising a terminal holder installed in the installation hole and holding an inserted terminal, the cylindrical shield is fitted onto the terminal holder, and the rear end of the terminal holder is inserted into a front end part of the shield blocking component.

16. The connector of claim 13, wherein the connector blind plug assembly has a sealing ring fitted onto a sealing ring installation part of the port blocking component, the sealing ring is radially compressed between an outer peripheral surface of the sealing ring installation part and an inner peripheral surface of the rear port of the installation hole to seal the rear port of the installation hole.

17. The connector of claim 13, wherein a plurality of installation holes are formed in the connector housing, and the connector comprises a plurality of cylindrical shields each inserted into one installation hole, the plurality of installation holes are independent and identical to each other, and the plurality of cylindrical shields are independent and identical to each other, the connector blind plug assembly is insertable into one of any of the plurality of installation holes.

18. The connector of claim 17, wherein the cable assembly has a cable and a shield connection element crimped onto a shielding layer of the cable, the shield connection element has a mating end mating with the rear end opening of the cylindrical shield, the cable assembly is inserted into at least one of the plurality of installation holes, and the connector blind plug assembly is inserted into an installation hole that the cable assembly is not inserted into.

19. The connector of claim 17, wherein the cable assembly is not inserted into any of the plurality of installation holes of the connector, and one connector blind plug assembly is inserted into each installation hole.

20. The connector of claim 18, wherein the cable assembly has a terminal crimped onto one end of the cable and inserted into a terminal holder of the connector for mating with a mating terminal of a mating connector.

21. The connector of claim 13, further comprising a rear end cover locked onto the rear end of the connector housing, and a cable clamp accommodated in the rear end cover, a cylindrical extension part of the port blocking component of the connector blind plug assembly passes through the cable clamp and the rear end cover, the cylindrical extension part is fixed to the rear end of the connector housing by the cable clamp and the rear end cover.
